(19) United States
(12) Patent Application Publication
(10) Pub. No.: US 2006/0256089 A1
(43) Pub. Date: Nov. 16, 2006

(54) System and method for providing virtual keys in a capacitive technology based user input device

(75) Inventor: Filip Atanassov, Oakville (CA)

Correspondence Address: Carter, DeLuca, Farrell & Schmidt, LLP;Suite 225, 445 Broad Hollow Road, Melville, NY, 11747, US

(73) Assignee: Tyco Electronics Canada Ltd.

(21) Appl. No.: 11/125,872

(22) Filed: May 10, 2005

(51) Int. Cl. G09G 5/00

(52) U.S. Cl. 345/173

(57) ABSTRACT

A user input device (UID) having a slide panel and a microcontroller is provided. The slide panel includes a plurality of sensors arranged in a pattern having at least one pair of adjacent sensors. Upon operation of the slide panel, including an operator sliding action along the slide panel, respective sensors of the plurality of sensors generate a signal indicative of activation of the corresponding sensor. The microcontroller receives the signals generated by the respective sensors responsive to the operation, and for a valid combination of received signals generates an output signal corresponding to the received signals. When the received signals indicate activation of one sensor of a pair of adjacent sensors of the at least one pair of adjacent sensors, the output signal corresponds to a first output state, and when the received signals indicate activation of both sensors of the pair of adjacent sensors, the output signal corresponds to a second output state.

### BACKGROUND

1. Field

The present disclosure relates to a capacitive sensor based user input device. In particular, the present disclosure relates to a system and method for providing virtual keys in a capacitive technology based user input device.

2. Description of the Related Art

Capacitive technology based user input devices (UIDs), such as sliders or touch pads, are provided for providing input to electronic devices for controlling gradient changes of an output of the device. For example, a capacitive technology based UID may be provided with a lighting device to control lighting intensity, with a kitchen oven to control oven temperature, with an MP3 player device to control sound volume, with a treadmill exercise machine to control speed or incline, with a power saw to control speed, with a medical imaging device to control energy intensity, etc. A capacitive technology based UID is operated by a sliding movement of a finger of a user across a slide panel of the UID. Other possible movements or gestures on the UID include single touches, touch and drag, touch and release, slide or swipe and hold, swipe and release, etc. The capacitive technology based UID may be provided with a microcontroller for responding to user operation of the UID and outputting control signals to a host processor of the electrical device. The slide panel of the UID is provided with a plurality of sensors which sense the sliding movement. Decreasing the number of sensors without decreasing the number of possible output states of the UID is desirable for decreasing the number of components provided with the UID, decreasing the number of pins of the microcontroller devoted to receiving sensor outputs, decreasing the size requirements of the UID and decreasing the cost of the UID.

### SUMMARY

In accordance with one aspect of the present disclosure there is provided a user input device (UID) including a slide panel and a microcontroller. The slide panel includes a plurality of sensors arranged in a pattern having at least one pair of adjacent sensors. Upon operation of the slide panel, including an operator sliding action along the slide panel, respective sensors of the plurality of sensors generate a signal indicative of activation of the corresponding sensor. The microcontroller receives the signals generated by the respective sensors responsive to the operation, and for a valid combination of received signals generates an output signal corresponding to the received signals. When the received signals indicate activation of one sensor of a pair of adjacent sensors of the at least one pair of adjacent sensors, the output signal corresponds to a first output state, and when the received signals indicate activation of both sensors of the pair of adjacent sensors, the output signal corresponds to a second output state.

Pursuant to another aspect of the present disclosure, there is provided a method for processing signals output by a panel of capacitive touch sensors arranged in a pattern having at least one pair of adjacent sensors. The method includes receiving a combination of signals indicative of activation of corresponding sensors in response to operation of the slide panel, which includes an operator sliding action along the slide panel. The method further includes processing the received combination of signals to determine if the combination of signals is valid, and generating an output signal corresponding to the received combination of signals for a valid combination of received signals. When the received combination of signals indicates activation of one sensor of a pair of adjacent sensors of the at least one pair of adjacent sensors, the output signal corresponds to a first output state, and when the received combination of signals indicate activation of both sensors of the pair of adjacent sensors the output signal corresponds to a second output state.

Pursuant to yet another aspect of the present disclosure, a microcontroller is provided for processing signals output by a panel of capacitive touch sensors arranged in a pattern having at least one pair of adjacent sensors. The microcontroller includes at least one input/output (I/O port for receiving a combination of signals indicative of activation of corresponding sensors in response to operation of the slide panel, including an operator sliding action along the slide panel, and outputting a corresponding output signal. The microcontroller further includes at least one processing device for processing the received combination of signals and generating the output signal for a valid combination of received signals. When the received combination of signals indicates activation of one sensor of a pair of adjacent sensors of the at least one pair of adjacent sensors, the output signal corresponds to a first output state, and when the received combination of signals indicate activation of both sensors of the pair of adjacent sensors the output signal corresponds to a second output state.

### BRIEF DESCRIPTION OF THE DRAWINGS

Various embodiments of the disclosure will be described herein below with reference to the figures wherein:

FIG. 1 is a block diagram of a user input device (UID) in operative communication with a host processor in accordance with the present disclosure;

FIG. 2 is a schematic representation of one configuration of keys of a UID in accordance with the present disclosure; and

FIG. 3 is a schematic representation of another configuration of keys of a UID in accordance with the present disclosure.

### DETAILED DESCRIPTION OF THE PREFERRED EMBODIMENTS

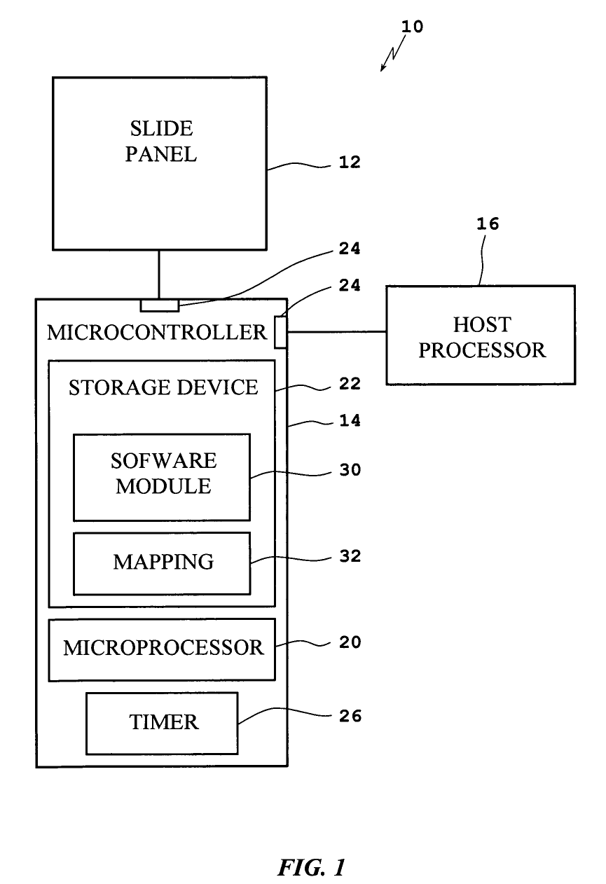

Reference should be made to the drawings where like reference numerals refer to similar elements throughout the various figures. With reference to FIG. 1, a capacitive technology based user input device (UID) 10 (also known as a slider) is shown, including capacitive technology slide panel 12 and a microcontroller 14 receiving signals from the slide panel 12. A host processor 16 of an electrical device receives control signals from the microcontroller 14. The electrical device is a device such as an MP3 player, a remote control device, an electrical industrial or medical tool, a house hold appliance, a control console for another electrical device, etc. The electrical device is typically controlled by user operation of the UID 10 for incrementally changing or causing a gradient change to a value or property associated with operation of the electrical device, such as sound volume for an MP3 player, curser control of a display device for a processing device, temperature for an oven, etc. The slide panel 12, microcontroller 14 and the host processor 16 may all reside in the electrical device. Alternatively, the slide panel 12 and/or the microcontroller 14 may be provided as peripheral units to the electrical device.

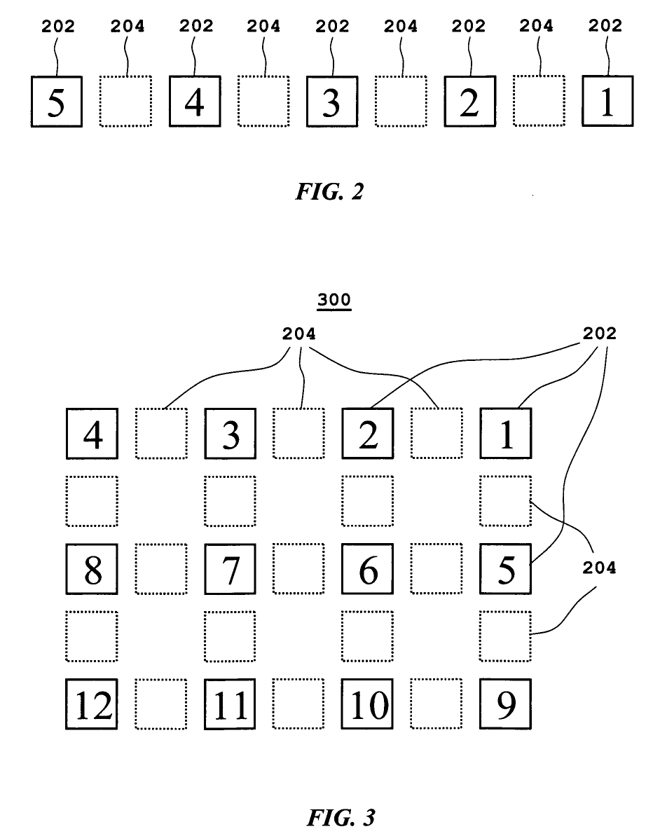

With reference to FIGS. 2 and 3, the slide panel 12 includes N capacitive touch sensors 202, which when activated operate as keys, and are referred to herein as keys or sensors. The sensors 202 are arranged in a pattern or configuration in which adjacent sensors 202 are provided, such as in a single row as is shown in FIG. 2, where the row may be formed as a line, an open curve, a closed curve (e.g., a wheel), or another formation. The capacitive touch sensors 202 may be arranged in more than row, such as in a matrix configuration or in concentric circles or semi-circles. The capacitive touch sensors 202 include devices which utilize the capacitive properties of a human or non-human body to detect the presence of said body.

When the slide panel 12 is operated by a user sliding a finger, or the equivalent, across the slide panel 12, the individual sensors 202 generate respective actuator signals, where an actuator signal has a high value when the sensor 202 is activated and a low value when the sensor 202 is not activated. Activation of a sensor 202 or two adjacent sensors 202 is effected, for example, by capactively sensing that a finger sliding over the slide panel 12 completes a slide by last touching the one sensor 202 or the adjacent sensors 202. The adjacent sensors 202 may include a cluster of more than two sensors 202, provided that the sensors 202 of the cluster of sensors are touched at the same time and each sensor 202 of the cluster of sensors is adjacent to another sensor 202 of the cluster of sensors. Other methods of activation are envisioned, and the present disclosure is not limited to the described method of activation. The actuator signals are combined into a slide signal which indicates which of the individual sensors 202 were activated. For example, the respective bits of a data portion of the slide signal may each correspond to an actuator signal generated by a particular sensor 202. The capacitive sensing may include sensing the finger sliding over a protective cover covering the sensors 202, such as a relatively thin layer of plastic or glass.

With returned reference to FIG. 1, the microcontroller 14 includes at least one microprocessor 20 having a CPU, at least one storage device 22 (e.g., RAM, ROM and/or PROM), input/output (I/O) ports 24 and at least one timer 26 for providing synchronization, or a combination thereof. The at least one storage device 22 may be provided external from the UID 10, and may be accessible by the microprocessor 20 of the microcontroller 14. The microcontroller 14 may be embedded in the host processor 16 or may be in operative communication with the host processor 16.

The microcontroller 14 receives slide signals generated by the slide panel 12 via the I/O ports 24. The microprocessor 20 processes the received signals and outputs at least one output signal, e.g., a control signal, which is output via the I/O ports 24 to the host processor 16 in the format and protocol appropriate for the host processor 16. The at least one storage device 22 stores a software module 30 including a series of programmable instructions executable by the CPU of the microprocessor 20 for processing the received slide signals and generating the output signals. The at least one storage device 22 further stores a data structure 32, such as a look-up-table, storing a plurality of first and second values, wherein at least a portion of the first values correspond to respective second values. In one embodiment of the disclosure, the first value is provided as an index for retrieving the second value when available.

The microprocessor 20 executes the software module 30 for processing received slide signals which were generated by the sensors 202 in response to operation of the slide panel 12. The microprocessor 20 accesses the data structure 32 for attempting to determine for a received slide signal a corresponding second value, such as by looking up the first value in a look-up-table of the data structure 32, for determining a first value which matches or corresponds to the slide signal. The first value which matches the slide signal may be determined by a search procedure, but is not limited thereto. The second value which corresponds to the determined first value is retrieved. If a first value cannot be determined which matches the slide signal, e.g., corresponds to the slide signal, or if a corresponding second value is not provided for a first signal which matches the slide signal, then the operation of the slide panel 12 is determined to be invalid. Typically, the current output state of the UID 10 does not change when an invalid operation is recognized, and the microprocessor waits for receipt of a next slide signal. Other treatments of an invalid operation are envisioned. If the operation of the slide panel 12 is determined to be valid, the retrieved second signal is output by the microcontroller 14 to the host processor 16. Different output values correspond to different output states.

In the data structure 32, a first value and respective corresponding second value is provided for corresponding to each slide signal indicative of activation of a single sensor 202 for each of the valid sensors 202. Furthermore, in the data structure 32, a first value and respective corresponding second value is provided for corresponding to each slide signal indicative of activation of adjacent sensors 202 for each valid combination of adjacent sensors 202. Accordingly, for each valid operation in which a valid single sensor 202 or a valid combination of adjacent sensors 202 is activated, an output state is provided, wherein each output state may be unique.

With respect, again, to FIG. 2 and to exemplary Table 1 below, a series of five sensors or keys 202 are provided, numbered 1-5. Table 1 shows the slide signal generated for each exemplary valid operation in which one sensor 202 or two adjacent sensors 202 are activated with the corresponding output states. Each bit of the slide signal corresponds to the actuator signal for one of the sensors 202, with the least significant bit corresponding to the actuator signal for the first sensor 202 of the series, sensor 1, the next significant bit corresponding to the next sensor of the series, and so forth, and the most significant bit corresponding to the actuator signal for the last sensor 202 of the series, sensor 5.

Activation of each of the sensors 1-5 individually is a valid operation which provides a valid output. Furthermore, activation of the adjacent sensors 1-2, 2-3, 3-4 and 4-5 are each a valid operation, each providing a valid output. Nine valid outputs are provided, corresponding to nine output states A-I. Accordingly, each of the sensors 1-5 operates as an individual key which may be operated on by the motion of the operator's finger, and each of the adjacent sensor combinations 1-2, 2-3, 3-4 and 4-5 operates as a virtual key 204 which may be operated on by the motion of the operator's finger, as well.

In the example shown in FIG. 2 and Table 1, in which five sensors 202 or keys are provided, up to four virtual keys 204 are provided, where operation of the input keys 202 and virtual input keys 204 provide up to nine output states. Similarly, a series of N sensors configured in a single row may provide up to N-1 virtual keys and up to (2N-1) output states. Provision of the virtual keys 204 by processing combinations of adjacent keys 202 as valid operations for providing a valid output state allows the respective sensors 202 to be associated with more than one output state, particularly two output states if the sensor 202 is positioned at an end of the series of sensors 202, or three output states if the sensor 202 is positioned in the middle of the series of sensors 202. For example, sensor 1 is associated with output states A and B, and sensor 2 is associated with output states B, C and D.

TABLE 1

| SENSOR | VALUE 1 SLIDE SIGNAL | VALUE 2 |
|---|---|---|
| 1 | 00001 | OUTPUT A |
| 1-2 | 00011 | OUTPUT B |
| 2 | 00010 | OUTPUT C |
| 2-3 | 00110 | OUTPUT D |
| 3 | 00100 | OUTPUT E |
| 3-4 | 01100 | OUTPUT F |
| 4 | 01000 | OUTPUT G |
| 4-5 | 11000 | OUTPUT H |
| 5 | 10000 | OUTPUT I |

With respect to FIG. 3, a matrix 300 of 4×3 input keys 202, totaling 12 input keys are provided. Up to 17 virtual keys 204 are provided between adjacent keys 202, and up to 29 output states may be achieved. By providing the virtual keys 204 shown, the respective sensors may be associated with between three and five output states. For example, key 1 is associated with an output state corresponding to activation of keys 1, 1-2 or 1-5, and key 6 is associated with an output state corresponding to activation of keys 6, 6-2, 6-5, 6-7 and 6-10.

Advantageously, the number of valid input choices for slide panel 12 having N sensors is increased to more than N choices, providing an increased resolution of output values. Additionally, the number of possible output states is increased to more than N. The increased resolution is readily available to the operator by operating the slider panel in a conventional manner by sliding his finger. The increased resolution may be apparent to the operator by observing the effects while operating the slide panel 12; however, the achievement of the increased resolution by provision of virtual keys 204 may remain transparent to the operator. The operator may operate the slider panel 12 without knowledge of the existence of the virtual keys 204 and need not learn the combinations of actual keys 202 which are valid.

Activation of adjacent sensors may occur during conventional operation of the slider without the operator being aware that more than one sensor 202 or a virtual key 204 were activated. Furthermore, the increased resolution is attainable without hardware changes, such as increasing the number of sensors 202 or the number of inputs provided to the microcontroller 14. It is further envisioned that in order for a host processor 16 which currently operates with a UID having N sensors and no virtual keys to be able to operate with UID 10 having N sensors and additional virtual keys, hardware changes are not necessary, and few or no software changes may suffice in order for the host processor 16 to process the increased resolution of output signals.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

1. A user input device (UID) comprising:
a slide panel having a plurality of sensors arranged in a pattern having at least one pair of adjacent sensors, upon operation of the slide panel including an operator sliding action along the slide panel, respective sensors of the plurality of sensors generating a signal indicative of activation of the corresponding sensor; and
a microcontroller receiving the signals generated by the respective sensors responsive to the operation, and for a valid combination of received signals generating an output signal corresponding to the received signals;
wherein when the received signals indicate activation of one sensor of a pair of adjacent sensors of the at least one pair of adjacent sensors, the output signal corresponds to a first output state, and when the received signals indicate activation of both sensors of the pair of adjacent sensors the output signal corresponds to a second output state.

2. The UID according to claim 1, wherein the plurality of sensors are capacitive touch sensors.

3. The UID according to claim 1, wherein the plurality of sensors are arranged in a single row.

4. The UID according to claim 1, wherein the plurality of sensors are arranged in a matrix.

5. The UID according to claim 1, wherein the number of output states exceeds the number of sensors of the plurality of sensors.

6. The UID according to claim 1, wherein the plurality of sensors includes N sensors, and the number of output states is equal to or greater than (2N-1).

7. The UID according to claim 1, wherein the microcontroller comprises at least one processing device having access to at least one storage device for storing: (a) a series of executable instructions executable by the microprocessor; and (b) a data structure accessible by the at least one processing device;
wherein the data structure provides a series of first values corresponding respectively to valid combinations of signals generated by the respective sensors, including at least one combination of signals indicative of activation of a pair of adjacent sensors, which correspond to respective second values, the second values corresponding to respective output states; and
wherein the at least one processing device executes the series of executable instructions for accessing the data structure to determine for a first value that matches the received combination of signals and retrieves the second value corresponding to the determined first value and generates the output signal to correspond to an output state which corresponds to the retrieved second value.

8. The UID according to claim 1, wherein the microcontroller is in operative communication with a host processor of an electrical device.

9. A method for processing signals output by a panel of capacitive touch sensors arranged in a pattern having at least one pair of adjacent sensors, comprising:
receiving a combination of signals indicative of activation of corresponding sensors in response to operation of the slide panel including an operator sliding action along the slide panel;
processing the received combination of signals to determine if the combination of signals is valid; and
generating an output signal corresponding to the received combination of signals for a valid combination of received signals;
wherein when the received combination of signals indicates activation of one sensor of a pair of adjacent sensors of the at least one pair of adjacent sensors, the output signal corresponds to a first output state, and when the received combination of signals indicate activation of both sensors of the pair of adjacent sensors the output signal corresponds to a second output state.

10. The method according to claim 9, wherein the number of output states exceeds the number of sensors of the panel.

11. The method according to claim 9, wherein the panel includes N sensors, and the number of output states is equal to or greater than (2N-1).

12. The method according to claim 9, further comprising:
accessing a data structure which provides a series of first values corresponding respectively to valid combinations of signals generated by the respective sensors, including at least one combination of signals indicative of activation of a pair of adjacent sensors, which correspond to respective second values, the second values corresponding to respective output states; and
determining a first value that matches the received combination of signals; and
retrieving the second value which corresponds to the determined first value;
wherein the output signal is generated to correspond to an output state which corresponds to the retrieved second value.

13. The method according to claim 9, further comprising transmitting the output control to a host processor of an electrical device.

14. The method according to claim 9, further comprising controlling gradient changes of operation of an electrical device using the output signal.

15. A microcontroller for processing signals output by a panel of capacitive touch sensors arranged in a pattern having at least one pair of adjacent sensors;
at least one input/output (I/O port for receiving a combination of signals indicative of activation of corresponding sensors in response to operation of the slide panel including an operator sliding action along the slide panel and outputting a corresponding output signal; and
at least one processing device for processing the received combination of signals and generating the output signal for a valid combination of received signals;
wherein when the received combination of signals indicates activation of one sensor of a pair of adjacent sensors of the at least one pair of adjacent sensors, the output signal corresponds to a first output state, and when the received combination of signals indicate activation of both sensors of the pair of adjacent sensors the output signal corresponds to a second output state.

16. The microcontroller according to claim 15, wherein the number of output states exceeds the number of sensors of the plurality of sensors.

17. The microcontroller according to claim 15, wherein the plurality of sensors includes N sensors, and the number of output states is equal to or greater than (2N-1).

18. The microcontroller according to claim 15, wherein the microcontroller comprises at least one storage device storing: (a) a series of executable instructions executable by the microprocessor; and (b) a data structure accessible by the at least one processing device;
wherein the data structure provides a series of first values corresponding respectively to valid combinations of signals generated by the respective sensors, including at least one combination of signals indicative of activation of a pair of adjacent sensors, which correspond to respective second values, the second values corresponding to respective output states; and
wherein the at least one processing device executes the series of executable instructions for accessing the data structure, determining a first value that matches the received combination of signals, retrieving the second value which corresponds to the determined first value, and generating the output signal to correspond to an output state which corresponds to the retrieved second value.

19. The microcontroller according to claim 15, wherein the microcontroller is embedded in a host processor of an electrical device.

20. The microcontroller according to claim 15, wherein the microcontroller is in operative communication with a host processor of an electrical device.
